(19) United States
(12) Patent Application Publication
(10) Pub. No.: US 2010/0140973 A1
(43) Pub. Date: Jun. 10, 2010

(54) PICK UP TRUCK TONNEAU COVER WITH TAILGATE STORAGE

(76) Inventor: Antonio Duncan, Detroit, MI (US)

Correspondence Address: JOHN R. BENEFIEL, 525 Lewis Street, BIRMINGHAM, MI, 48009, US

(21) Appl. No.: 12/605,656

(22) Filed: Oct. 26, 2009

Related U.S. Application Data
(63) Continuation-in-part of application No. 12/077,212, filed on Mar. 19, 2008, now abandoned.

(51) Int. Cl. B60P 7/02

(52) U.S. Cl. 296/100.09

(57) ABSTRACT

A multi-section tonneau cover for a pickup cargo box which folds up to form a stack which is than stowable in a cavity in the pickup tailgate. Intermediate section panels and special hinged connections allow a roll-up type folding pattern so that a waterproof cover layer can be attaching extending over all of the section panels without interfering with the folding up of said main section panels.

### CROSS REFERENCE TO RELATED APPLICATIONS

This application is a continuation-in-part of U.S. application Ser. No. 12/077,212 filed on Mar. 19, 2008.

### BACKGROUND OF THE INVENTION

This invention concerns tonneau covers and more specifically foldup tonneau covers for pick up truck cargo boxes.

Tonneau covers (also called truck covers) are typically mounted atop a pickup truck's cargo box to protect its contents from rain, snow, hail, wind, airborne or falling debris, sun exposure, etc. Tonneau covers also reduce a pickup truck's fuel consumption by making the truck's cargo box more streamlined.

A problem with the tonneau covers currently available is that when the cover is removed from a deployed position atop the truck's cargo box there is no place on the vehicle other than the truck's cargo box to store it, thus reducing the available space. While multi-section fold up tonneau covers have previously been devised, a problem is encountered in providing a waterproof cover as leakage between the sections could occur. If a waterproof layer were included extending over the section joints, the fold up patterns used previously, would create difficulties since an outer continuous cover layer extending over the hinged joint would interfere with the folding process as it would have to be stretched when the sections were folded up.

An object of the present invention is to provide convenient in-vehicle storage for the folded up tonneau cover.

Another object of the present invention is to provide a fold up tonneau cover which has a continuous waterproof cover layer extending over the section joints which is not stretched when the tonneau cover sections are folded up.

### SUMMARY OF THE INVENTION

The above recited objects and other objects which will be appreciated by those skilled in the art upon a reading of the following specification and claims are achieved by an interconnection between a series of side by side main section panels, which interconnection allows each main section panel to be folded over onto the next section panel to the rear, with those stacked sections then folded over onto the next section. This “roll up” folding pattern avoids stretching of a water proof outer cover layer and conveniently results in a fully folded up tonneau cover disposed at the rear of the cargo box.

The tailgate is configured as a storage box with a cavity configured to completely receive and enclose the folded up tonneau cover. A hinged lid can also be provided to protect the stowed tonneau cover.

The tonneau cover can therefore be conveniently removed from its position atop the truck's cargo box and its sections folded up into a compact stack, and then placed inside of an associated tailgate that has a built in storage space for the folded up tonneau cover.

The “roll up” folding pattern of the sections of the tonneau cover is enabled in an interconnection between the main section panels comprised of short intermediate sections disposed between successive main section panels along the cover, and hinged on both sides to the adjacent main section panels which assume a vertical position at the ends of stacked main section panels. The intermediate and main section panels are hinged to each other by a hinge which allows each main section starting at the forward most section to be swung up 90° on hinges on the adjacent side of an intermediate section panel until a bottom edge of the main section panel abuts the top of the adjacent intermediate section panel, and then swung down atop the next main section panel to be stacked thereon by a hinging connection between the other side of intermediate section and the next main section panel. This process continues with the stacked main section panels swung up on one hinged connection to one side of an intermediate section panel then swung down onto the next main section panel by a hinged connection to the other side of the intermediate section panel, with the intermediate section panel disposed at the ends of the stacked main section panels. This folding process continues until all of the main section panels are stacked atop each other at the rear of the cargo box.

The fold up tonneau cover may then be conveniently placed inside of the truck's tailgate storage cavity which may have a cover which can be opened up to receive the folded tonneau cover into the storage cavity. Alternatively, the folded up tonneau cover may simply be secured in a recess or cavity built into the tailgate.

The aforementioned process of removing and storing the tonneau cover is reversed when the tonneau cover is removed from the tailgate storage cavity and deployed atop the cargo box.

The folded up tonneau cover and its associated tailgate storage cavity allows the tonneau cover to be with the vehicle at all times without sacrificing space in the cargo box or passenger cab.

### DESCRIPTION OF THE DRAWING FIGURES

FIG. 1 is a perspective view of a pickup truck with the section panels of a cover according to the invention shown deployed (i.e., unfolded and located in position atop the cargo box) with an overlying waterproof cover layer shown in a cut away view.

FIG. 2 is a perspective view of a tonneau cover according to the invention shown unattached from a vehicle and fully unfolded with overlying waterproof cover layer shown in a cut away view.

FIG. 3 is a perspective view of the rear section of a pickup truck with a tonneau cover according to the invention fully deployed over the cargo box.

FIG. 4 is a perspective view of the rear section of a pickup truck with the tonneau cover according to the invention in a first stage of the fold-up process.

FIG. 5 is a perspective view of the rear section of a pickup truck with the tonneau cover according to the invention in a second stage of the fold-up process.

FIG. 6 is a perspective view of the rear section of a pickup truck with the tonneau cover according to the invention in a third stage of the fold-up process.

FIG. 7 is a perspective view of the rear section of a pickup truck with the tonneau cover according to the invention in a fourth stage of the fold-up process.

FIG. 8 is a perspective view of the rear section of a pickup truck with the tonneau cover according to the invention in a fifth stage of the fold-up process.

FIG. 9 is a perspective view of the rear section of a pickup truck with the tonneau cover according to the invention in the sixth and final stage of the fold-up process, with the tailgate shown in its opened horizontal position, and with an access cover opened to expose an internal storage cavity.

FIG. 10 is a perspective view of the rear section of a pickup truck with the folded up tonneau cover stored inside the pickup truck tailgate.

FIG. 11 is a perspective view of the rear section of a pickup truck with the folded up tonneau cover according to the invention stored inside the pickup truck tailgate and the access cover to the tailgate storage cavity closed.

FIG. 12 is a perspective elongated view of a typical double hinge connection between main and intermediate section panels.

FIG. 13A through 13G are diagrammatic end views of the section panels of the tonneau cover in successive stages of being folding up.

FIGS. 14A and 14B are enlarged fragmentary diagrammatic representations of the front and rear ends of a folded up tonneau cover according to the invention showing details of the cover layer folded up.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

In the following description of the invention, like numerals and characters designate like elements throughout the Figures of the drawings.

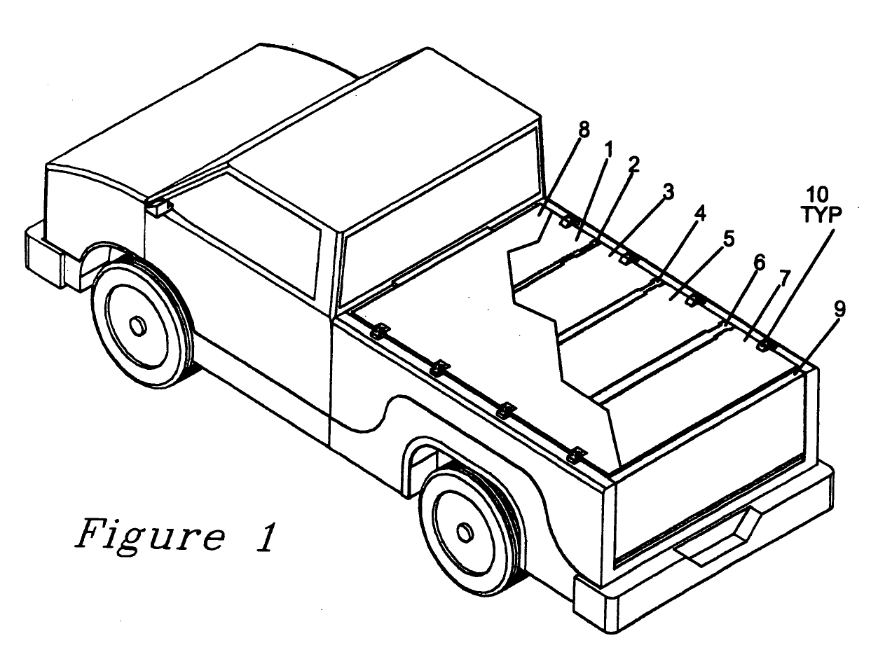

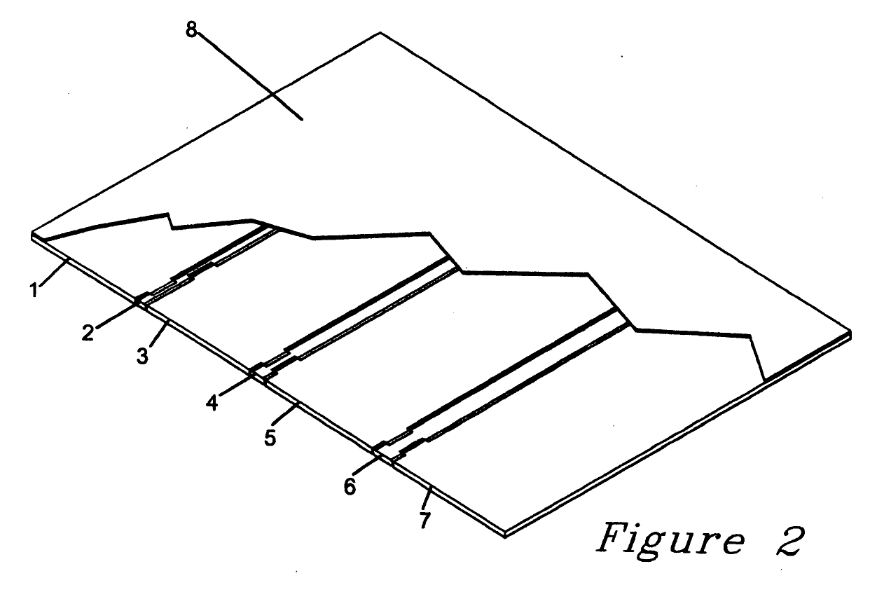

The tonneau or truck bed cover according to the invention is comprised of a plurality of section panels 1-7, each substantially rigid and generally rectangular, which are hinged together along their adjacent longitudinal edges. The section panels 1-7 extend transversely across the top opening of a pickup truck's cargo box (see FIG. 1) and are sufficiently wide to completely span the cargo box inside width.

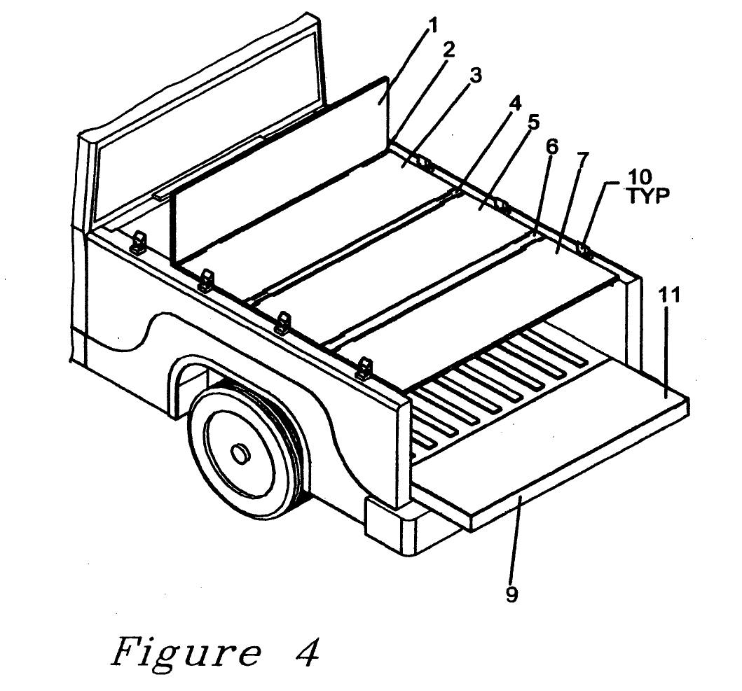

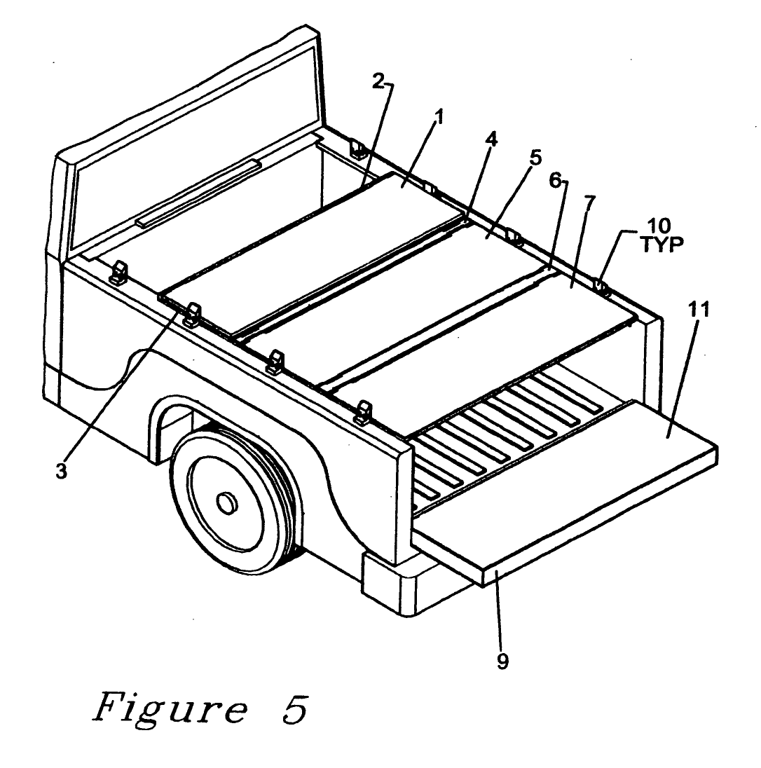

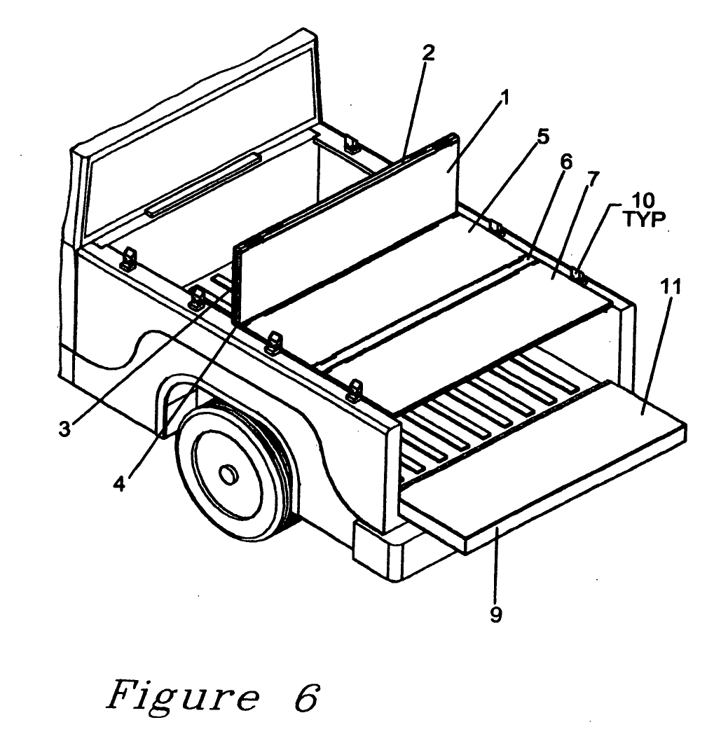

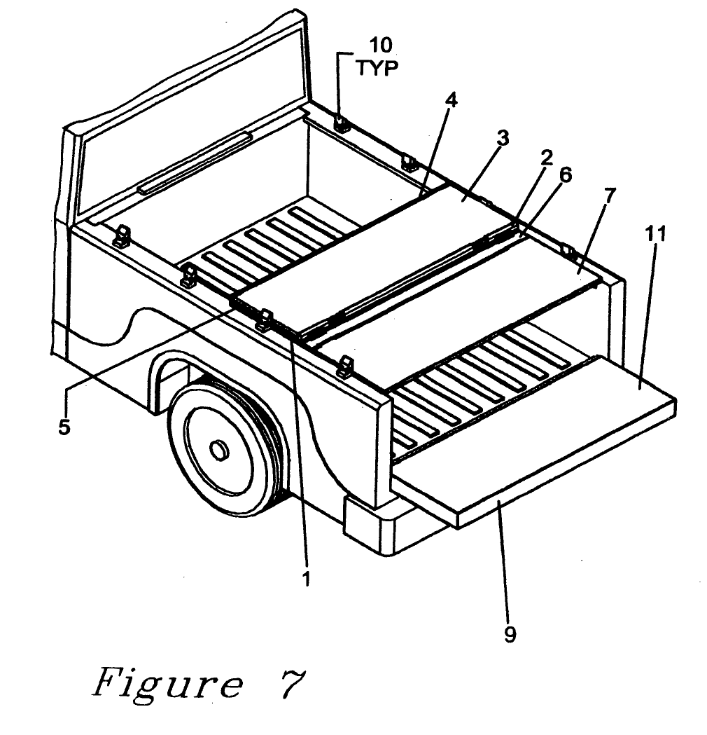

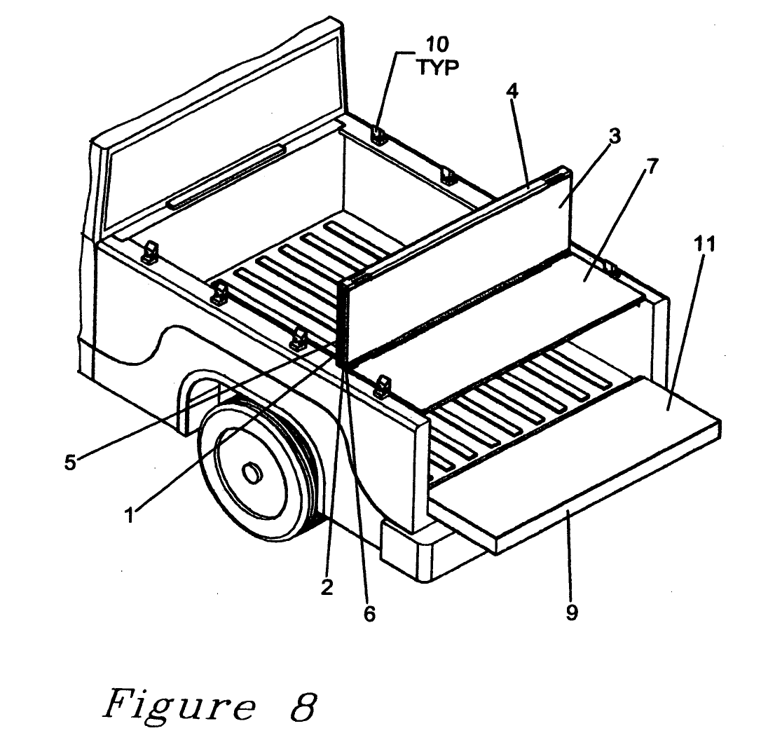

Referring to FIGS. 4-9, the section panels 1-7 are hinged together in such a way as to allow them to be folded onto each other until all the section panels are brought into a compact stack.

A moisture repellant flexible cover layer 8 is preferably affixed to the exposed sides of the panels 1-7, since the cover 8 is flexible and does not interfere with the aforementioned fold-up process of the panels 1-7 as described in further detail herein.

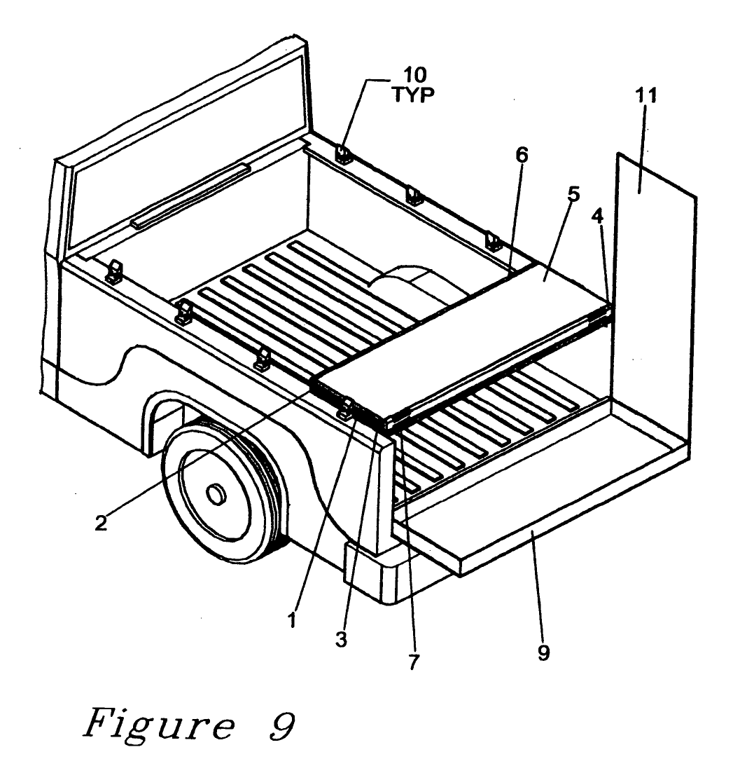

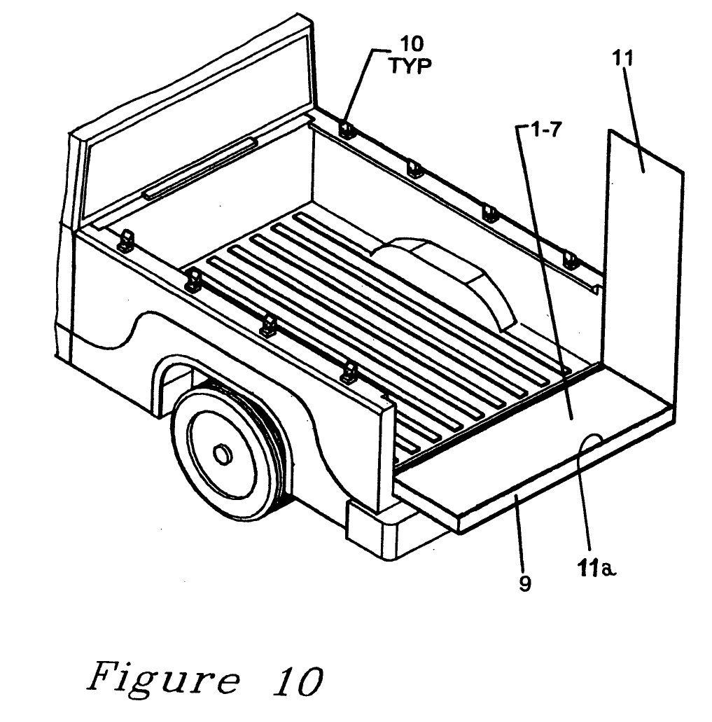

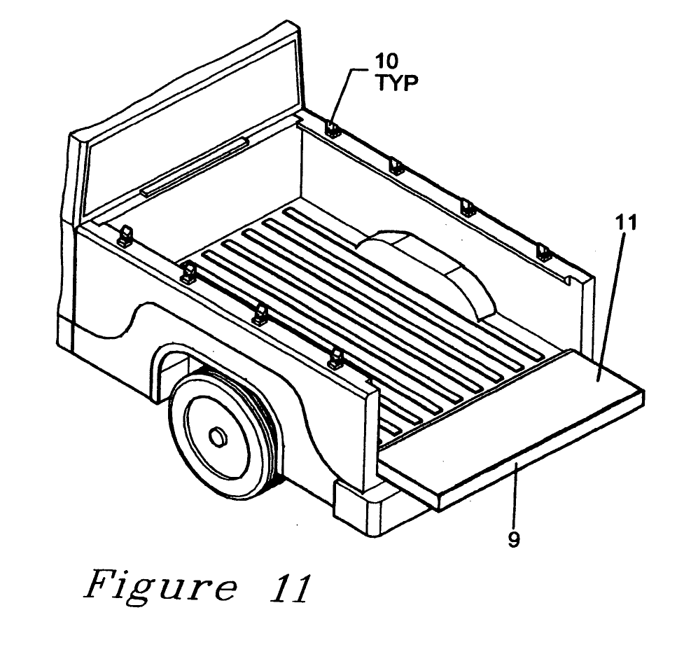

Referring to FIGS. 9-11 the tailgate 9 according to one aspect of the invention has an access cover 11 that opens to an exposed cavity 11A defined inside the tailgate 9, the cavity 11A configured to be able to receive and completely enclose the folded up section panels of the tonneau cover to serve as a storage compartment for the folded up cover. Once the folded up panels 1-7 are placed inside the tailgate 9, the access cover 11 is closed, thus concealing the panels 1-7 from view, stowing them in an out of the way protected location in the vehicle.

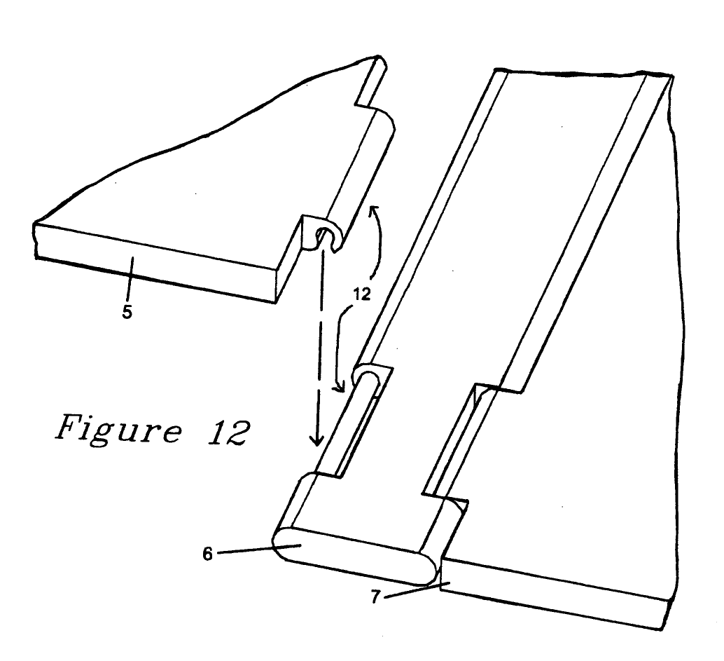

Referring to FIG. 12, an enlarged fragmentary view of one of two double hinged connections 12 between main section panels 5 and 7 and an intermediate section panel 6, a broken line and arrow showing the direction of movement for the main section panel 5 as it is swung up to 90° until abutting one end against intermediate section panel 6. The hinged connection 12 shown is a snap-together hinge connection.

The double hinged connection 12 shown allows each main section panel 1, 3, 5, 7 to rotate 180° by first being swung up 90° on a hinge connection of the adjacent side of an associated intermediate section panels 2, 4, 6. The hinged connection shown in FIG. 12 is typical of all the hinged connections between the section panels 1-7 of the invention. Two double hinged connections 12 are used between the adjacent edges of the section panels 1-7.

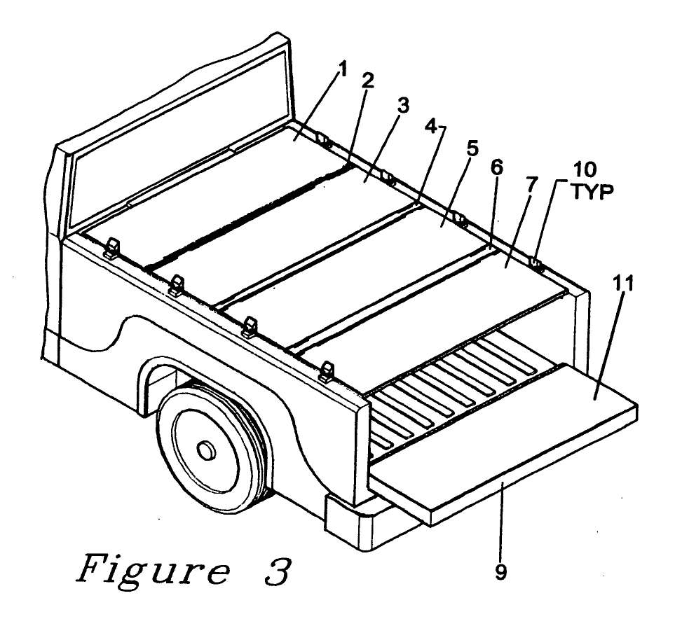

Clamps 10 attached along the tops of the vertical sidewalls of the pickup truck's cargo box serve the purpose of holding the panels 1-7 firmly atop the cargo box in the deployed position (see FIG. 1). The clamps 10 can be released to allow the section panels 1-7 to be moved (see FIGS. 3-11).

In FIGS. 3-10 and 12 the section panels 1-7 are shown without the preferred single flexible cover layer 8 overlying all of the section panels 1-7 so as to provide an unobstructed view of the section panels 1-7. The tonneau cover functions in the same manner with or without a flexible cover 8 in place.

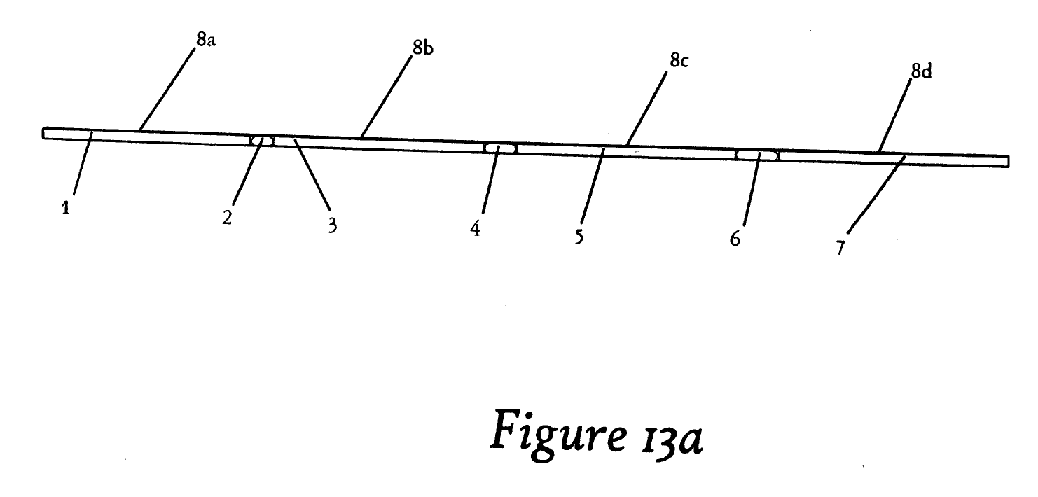

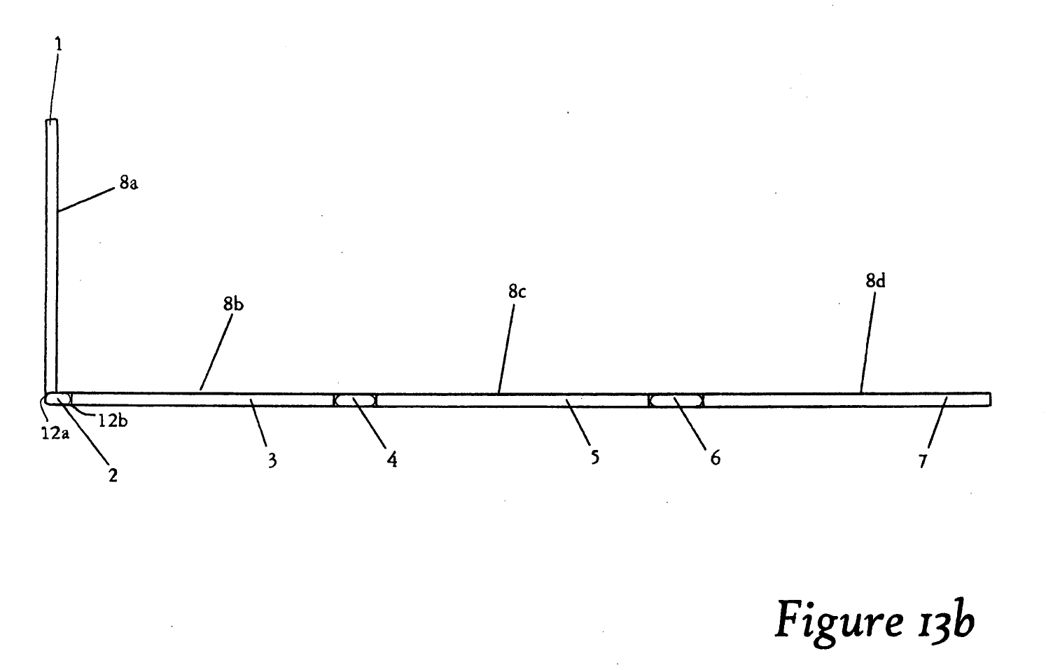

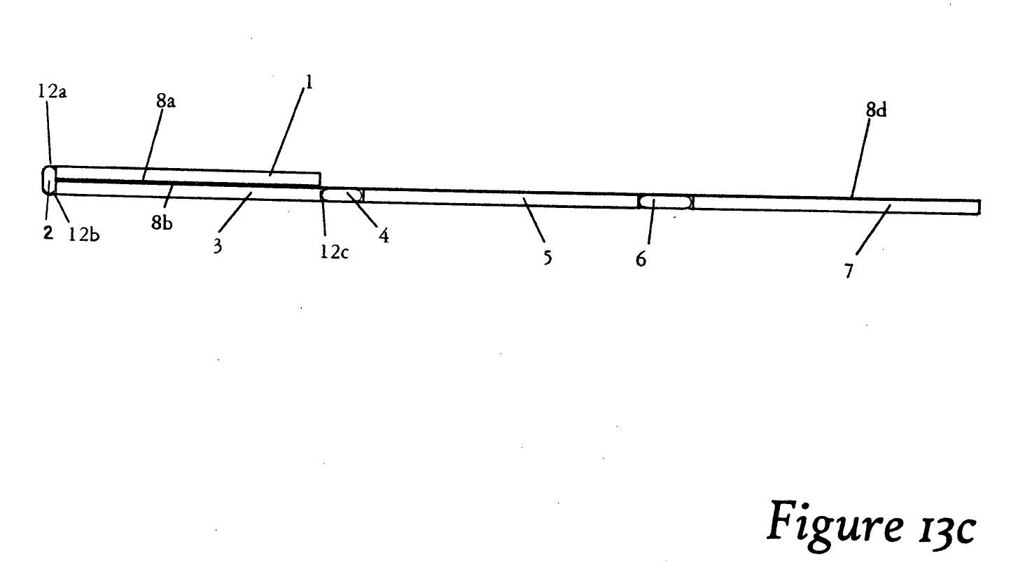

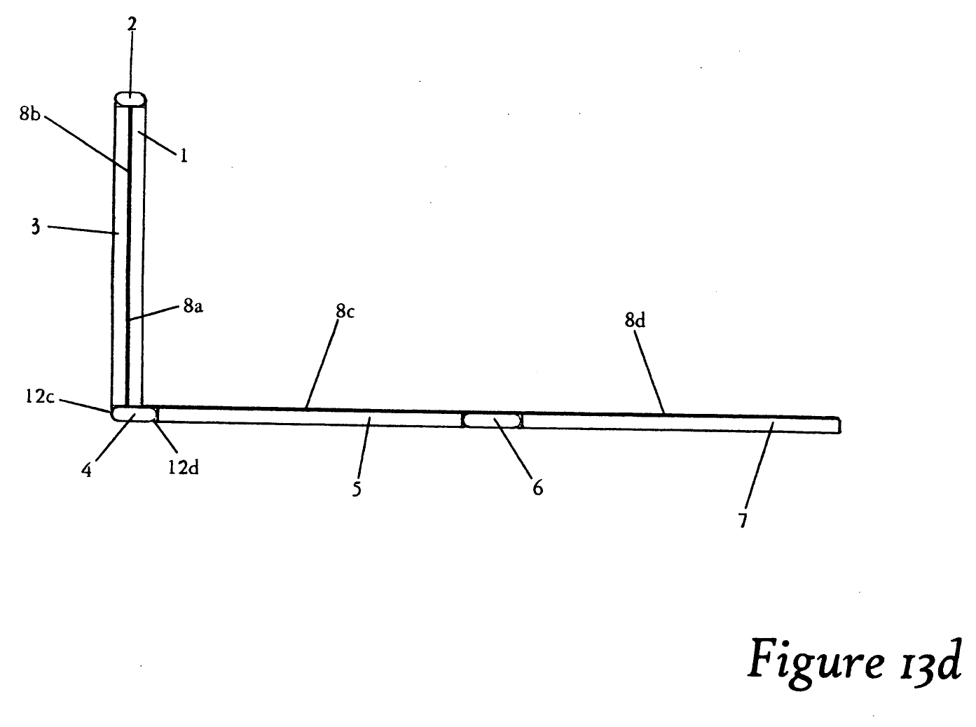

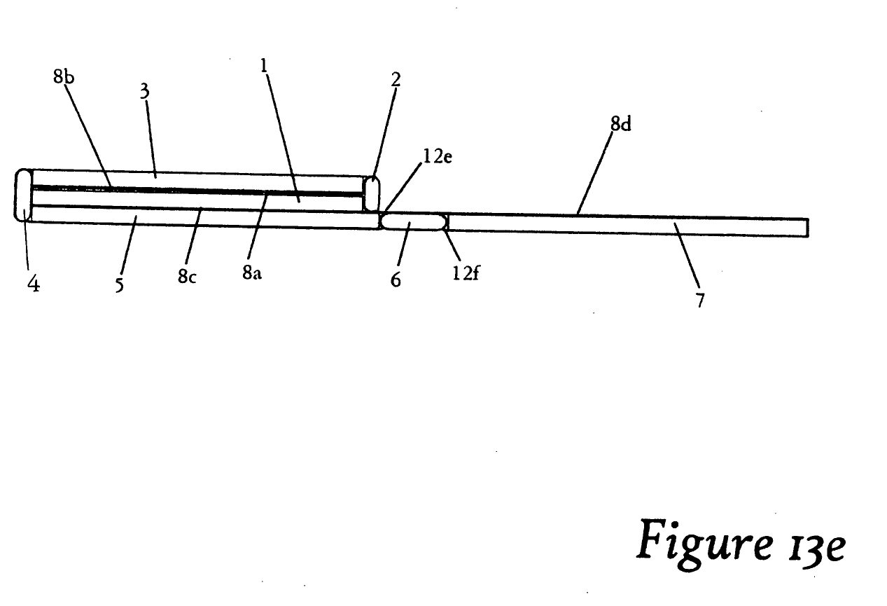

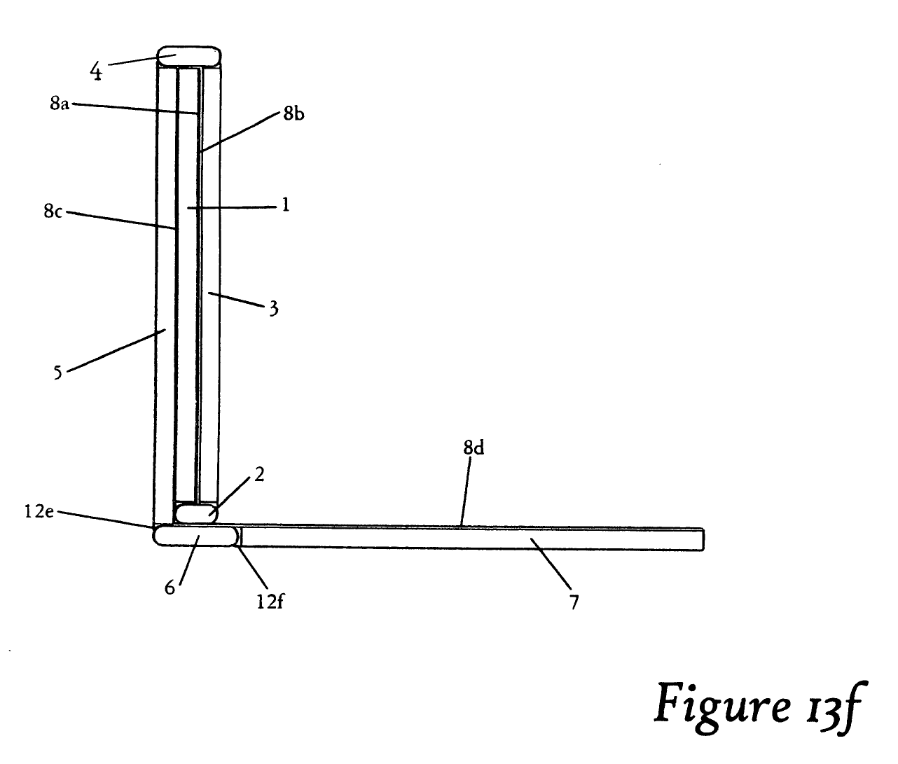

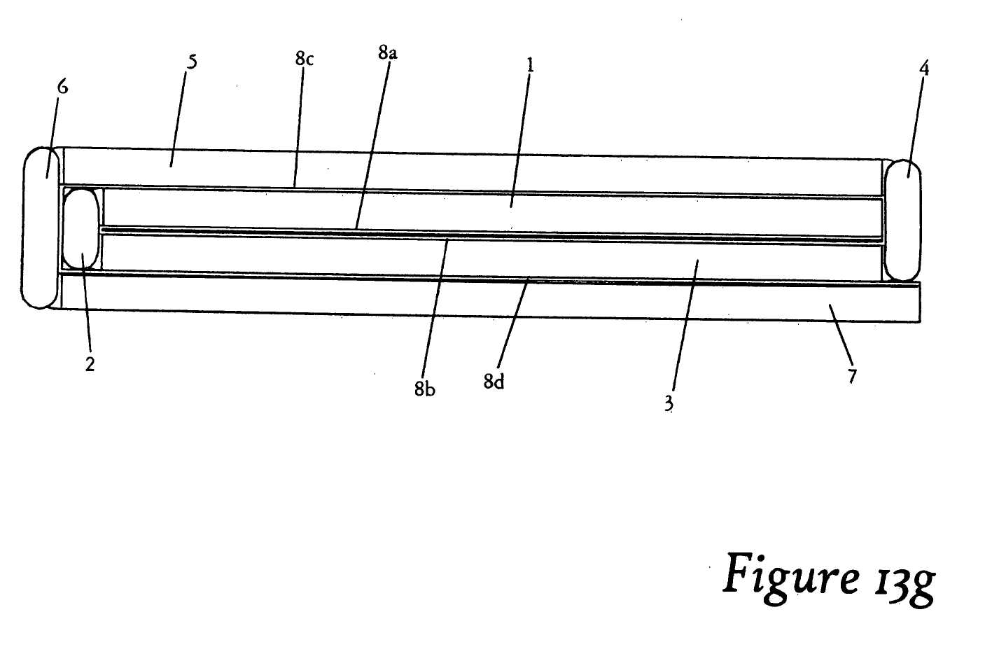

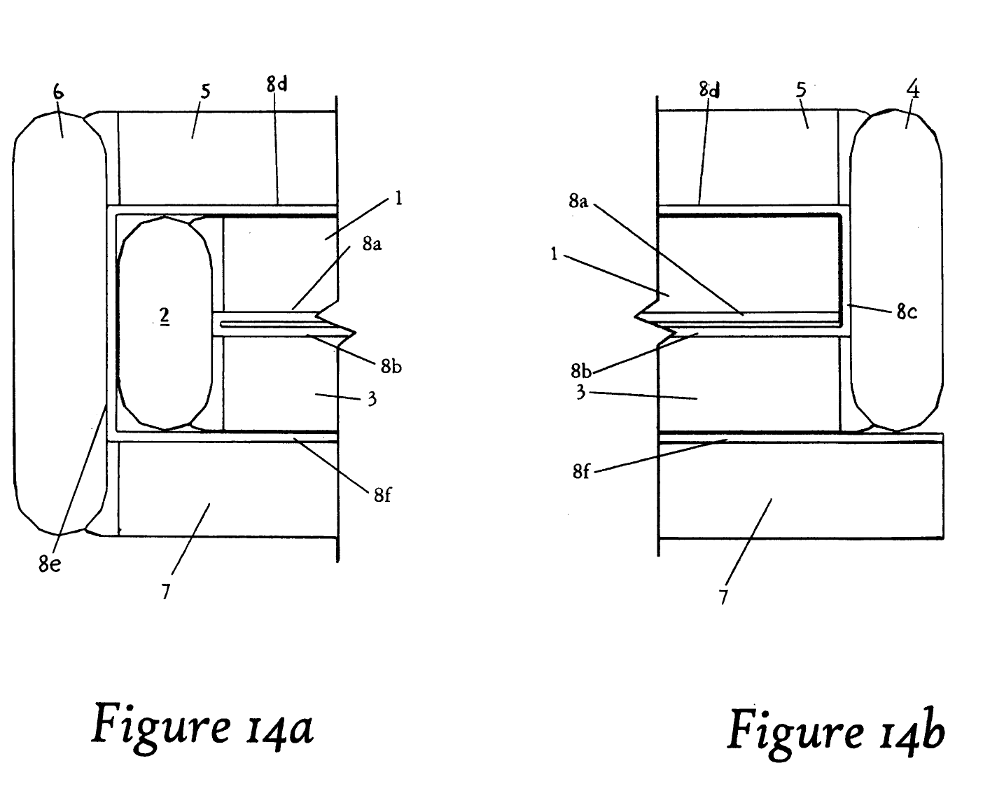

Referring to FIGS. 13A-13G and 14A, B, the section panels 1-7 are shown somewhat diagrammatically interconnected with pairs of hinged connections 12 of a type depicted in FIG. 12.

As a first step, the forward-most main section panel 1 is swung up 90° as seen in FIG. 13B allowed by the hinged connections 12A between the first main panel section 1 and one side of the adjacent shorter intermediate panel section 2. The end face of the main section panel 1 is brought into abutment against one side of the top of the intermediate section panel 2, preventing any further rotation about hinged connections 12A.

Upon continued movement of the main section panel 1 further pivoting on the hinge connections 12A is prevented by the hinged end of the section panel 1 abutting the top of the intermediate section panel 2.

As seen in FIG. 13B, the hinge connections 12B then become operative, causing intermediate section panel 2 to pivot up 90° on hinged connections 12B to allow the main panel section 1 to complete a 180° rotation, swinging down to be positioned atop the next main section panel 3 as shown in FIG. 13C with the intermediate section panel 2 disposed vertically at the ends of the now stacked main panel sections 1 and 3. The shorter intermediate section panel 2 has a length equal to the combined thickness of the two stacked main section panels 1 and 3 so that all three section panels 1, 2, 3 are compactly folded together.

Next, the stacked main section panels 1 and 3 are both swung up 90° on hinged connections 12C between main section panel 3 and one side of the next intermediate section panel 4.

Further pivoting about hinged connections 12C is prevented by abutment of the ends of main section panels 1 and 3 with one side of the top of intermediate section panel 4.

The stacked main section panels 1 and 3 may be swung down by pivoting about hinged connections 12D connecting intermediate section panels 4 and the next main section panel 5, enabling stacked main section panels 1 and 3 to both be stacked onto section panel 5 as seen in FIG. 13E.

As seen in FIG. 13E, the intermediate section panel 4 has a length equal to the combined thickness of the three stacked main section panels, 1, 3, and 5 to be compactly folded together therewith.

As also seen in FIG. 13E, main section panel 5 is longer than main section panels 1 and 3 by the thickness of the intermediate section panel 2.

All three stacked main section panels 1, 3, 5 (and connected intermediate section panels 2 and 4) may be swung up 90° on hinge connections 12E between the next main section panel 7 and the next intermediate section panel 6 to the vertical position shown in FIG. 13F with the end of main section panel 5 and the side of intermediate section panel 2 abutting one side of the top of intermediate section panel 6.

The three stacked main section panels 1, 3, 5 may be swung down as allowed by the hinge connections 12F, to be stacked onto main section panel 7 as seen in FIG. 13G.

The main section panel 7 is longer than main section panels 1 and 3 by the thickness of the two intermediate section panels 2 and 4 and longer than section panel 5 by the thickness of section panel 4.

It is noted that the hinge connections 12 have a particular geometry and are recessed as seen in FIG. 12 such that when the end of a connected section panel swings up, the other section panel to which it is hinged to bring its end into abutment with the top of the associated section panel in order to create the “roll up” folding pattern shown in FIGS. 13A-13G.

FIGS. 14A and 14B are enlarged details of the front and rear ends of the folded up tonneau cover and show how this folding pattern allows use of a single outer covering layer of flexible material without creating interference or binding in the hinge connections 12 caused by stretching of wrapped sections of the cover layer 8. This result is because the flexible cover 8 only undergoes inside folding when the section panels 1-7 are pivoted, which does not resist the pivoting of the section panels 1-7 nor stretch the cover layer 8 around a hinge connection.

FIG. 14B shows cover segment 8A on main section panel 1 which is folded to the inside with respect to cover segment 8B on main section panel 3 and folded over in FIG. 13C.

Segment 8B is folded to the inside with respect to segment 8C on intermediate section panel 4 and main panel section in FIG. 13D.

Segment 8D is folded to the inside from segment 8C and Segment 8E folded to the inside from segment 8D. Finally, segment 8E is folded to the inside from segment 8E.

The “roll up” folding pattern conveniently positions all of the stacked section panels at the rear of the cargo box adjacent to the tailgate 9.

The main section panels 1, 3, 5, and 7 may be molded from high strength plastic or fiberglass. The short intermediate section panels 2, 4, and 6 may be made of spring steel treated to prevent corrosion. The flexible cover 8 may be made from a material that resists the penetration of moisture such as pliable vinyl while being readily foldable. Cover layer 8 is attached to the external sides of each of the section panels 1-7 intermediate the hinged connections as with a waterproof adhesive, but not in the region of the hinged connections 12. The tailgate 9 may be made from sheet metal as per conventional practice, while the internal components of tailgate 9 such as the structural supports (not shown), and locking mechanisms (not shown) used to hold the tailgate 9 in the vertical closed position may all be of conventional design.

The above described tonneau cover is not limited to the exact details of construction, composition of materials, or enumeration of parts described herein. Furthermore, the shape and size can be varied. Although there has been shown and described the preferred embodiment of the present invention, it will be readily apparent to those skilled in the art that modifications may be made thereto within the scope of the appended claims.

1. A fold up tonneau cover for covering a pickup cargo box wherein the cargo box is an open topped space defined by two spaced-apart, generally vertical, and generally parallel to each other sidewalls, a generally vertical tailgate at a rear end of and at a right angle to the sidewalls, and a generally vertical wall adjacent to a passenger cabin, generally at a right angle to the sidewalls, and at an opposite end of the sidewalls from the tailgate; the tonneau cover comprising:
an end to end side series of substantially rigid and generally rectangular main section panels of a width spanning the distance between said cargo box sidewalls, with adjacent main section panels in said series interconnected so as to allow a first main section panel to be swung up and down onto the next main section panel to be stacked together, and said stacked first and next main section panels able to be swung up and down onto the next main section panel to be stacked together with said three stacked section panels then able to be swung up and down onto a next main section panel to be stacked thereon, and so on until all of said main section panels are stacked together.

2. The tonneau cover according to claim 1 wherein said first main section panel is normally positioned over a forward end of said cargo box so that said stack is formed at the rear end of said cargo box upon folding together all of said main section panels.

3. The tonneau cover according to claim 1 wherein said main section panels are interconnected by shorter intermediate section panels having hinged connections between adjacent main section panels at either end thereof, said hinged connections causing each end of main section panel to abut the top of said intermediate panel upon undergoing 90° pivoting movement, and thereafter hinged connection at the other end of said intermediate section panel to the next adjacent main section panel becoming operative to allow said main section panel to be swung down atop said next adjacent main section panel.

4. The tonneau cover according to claim 3 wherein said intermediate section panels are progressively greater in length from a first length substantially equal to the thickness of two stacked main section panels, the next intermediate section panels of a length equal to the thickness of said first and second panels stacked onto a next section panel and so on.

5. The fold up tonneau cover according to claim 1 wherein a waterproof flexible cover layer extends over and is attached to all of said main section panels.

6. The fold up tonneau cover according to claim 1 in combination with a pickup truck cargo box tailgate formed with a storage cavity able to receive and enclose said stack of section panels therein whereby enabling storage of said folded up section stack.

7. In combination, a fold-up tonneau cover comprised of a series of main section panels interconnected together to be able to be folded into a stack and a pickup truck cargo box tailgate formed with a storage cavity able to receive and enclose said stack of section panels therein whereby enabling storage of said folded up section stack.

8. The combination according to claim 7 wherein said tailgate cavity is provided with a cover able to be closed over said cavity to completely enclose said folded up stack of main section panels.
